(19) United States
(12) Patent Application Publication
(10) Pub. No.: US 2026/0349381 A1
(43) Pub. Date: Nov. 5, 2026

(54) IMAGE FORMING APPARATUS

(71) Applicant: SHARP KABUSHIKI KAISHA, Osaka (JP)

(72) Inventors: Akito TERAMOTO, Osaka (JP); Katsuaki Yamada, Osaka (JP); Kenzo Ohkubo, Osaka (JP)

(21) Appl. No.: 19/538,852

(22) Filed: Feb. 12, 2026

(30) Foreign Application Priority Data
Feb. 26, 2025 (JP) 2025-028892

(51) Int. Cl. G03G 21/16; G03G 15/04; G03G 21/12

(52) U.S. Cl. CPC G03G 21/1647; G03G 15/0409; G03G 21/12; G03G 2221/1618; G03G 2221/1636

(57) ABSTRACT

An image forming apparatus includes an image carrier, a print head that is elongated including a substrate having a plurality of light-emitting elements and a lens array, a detachable member attachable/detachable to/from an image forming apparatus body, and a moving device that moves the print head with respect to the image carrier. The moving device includes a lifting mechanism that lifts and lowers the print head in a lifting direction, and a lifting member that is movable in a predetermined moving direction orthogonal to the lifting direction. The lifting mechanism lowers the print head by the lifting member moving to one side in the moving direction when the detachable member is detached from the image forming apparatus body and raises the print head by the lifting member moving to the other side in the moving direction when the detachable member is detachably attached to the image forming apparatus body.

### CROSS-REFERENCE TO RELATED APPLICATION

The present application claims priority from Japanese Application JP 2025-028892, the content of which is hereby incorporated by reference into this application.

### BACKGROUND OF THE INVENTION

### 1. Field of the Invention

The present disclosure relates to an image forming apparatus such as a copier, a multifunction peripheral, a printer, and a facsimile apparatus.

### 2. Description of the Related Art

There is an image forming apparatus including: a print head that is elongated including a substrate having a plurality of light-emitting elements arrayed in a line and a lens array that condenses, onto an image carrier (e.g., a photoreceptor drum), light emitted by the plurality of light-emitting elements; a detachable member (e.g., a cartridge) attachable/detachable to/from an image forming apparatus body; and a moving device that moves the print head with respect to the image carrier in conjunction with attachment/detachment of the detachable member to/from the image forming apparatus body, thereby enabling a surface of the lens array to be easily cleaned.

For example, as a related art, there is a known image forming apparatus including an optical print head (print head) rotatable and movable to an exposure position, which is a position where a lens (lens array) opposes a photoreceptor drum (image carrier) in order to expose the photoreceptor drum, and a moving position moved upward from the exposure position in a vertical direction, in which the optical print head moves between the exposure position and the moving position in conjunction with attachment/detachment of a cartridge (detachable member) to/from a housing, and in a state where the cartridge is removed from the housing, the optical print head is positioned at the moving position.

### SUMMARY OF THE INVENTION

In such a known image forming apparatus, since the print head is rotated when moving the print head, a space for moving the print head is increased accordingly, and the image forming apparatus body is increased in size.

Therefore, an object of one aspect of the present disclosure is to provide an image forming apparatus that can reduce a space for moving a print head, thereby achieving downsizing of the image forming apparatus body.

In order to solve the problem, an image forming apparatus according to one aspect of the present disclosure includes: an image carrier; a print head that is elongated including a substrate having a plurality of light-emitting elements arrayed in a line and a lens array that condenses, onto the image carrier, light emitted by the plurality of light-emitting elements; a detachable member attachable/detachable to/from an image forming apparatus body; and a moving device that moves the print head with respect to the image carrier in conjunction with attachment/detachment of the detachable member to/from the image forming apparatus body, in which the moving device includes a lifting mechanism that lifts and lowers the print head in a lifting direction along an optical axis direction of the light-emitting elements, and a lifting member that is movable in a predetermined moving direction orthogonal to the lifting direction, and the lifting mechanism lowers the print head by the lifting member moving to one side in the moving direction when the detachable member is detached from the image forming apparatus body, and raises the print head by the lifting member moving to the other side in the moving direction when the detachable member is detachably attached to the image forming apparatus body.

According to one aspect of the present disclosure, it is possible to reduce a space for moving the print head, thereby achieving downsizing of the image forming apparatus body.

### BRIEF DESCRIPTION OF THE DRAWINGS

FIG. 1 is a cross-sectional view illustrating an image forming apparatus according to the present embodiment.

FIG. 2 is a perspective view of an example of a print head in the image forming apparatus according to the present embodiment provided at a main body frame, as viewed from obliquely above on the right side.

FIG. 3 is a perspective view of a state in which the print head illustrated in FIG. 2 is supported by an installation portion, as viewed from obliquely above on the right side.

FIG. 4 is a perspective view of the print head as viewed from obliquely above on the left.

FIG. 5 is a cross-sectional view schematically illustrating the print head.

FIG. 6 is a perspective view of a photoreceptor unit, the print head, and installation, as viewed from above on the left side.

FIG. 7 is a perspective view of a moving device portion on one side of the installation portion provided with the print head, as viewed from obliquely above.

FIG. 8 is an exploded perspective view of the print head and the installation portion illustrated in FIG. 7, as viewed from obliquely above.

FIG. 9 is an exploded perspective view of the print head and the installation portion illustrated in FIG. 7, as viewed from obliquely below.

FIG. 10 is a perspective view of the moving device portion on the other side of the installation portion provided with the print head, as viewed from obliquely above.

FIG. 11 is an exploded perspective view of the print head and the installation portion illustrated in FIG. 10, as viewed from obliquely above.

FIG. 12 is an exploded perspective view of the print head and the installation portion illustrated in FIG. 10, as viewed from obliquely below.

FIG. 13 is a perspective view of a state in which an exterior cover member on a surface of a right side is removed in the image forming apparatus, as viewed from obliquely above and behind the right side.

FIG. 14 is a perspective view of an integrated cartridge including a toner container and a waste toner container, as viewed from obliquely above and behind the left side.

FIG. 15 is a perspective view of an end portion on the right side of the moving device in the image forming apparatus body, as viewed from obliquely above and behind.

FIG. 16 is a perspective view of an end portion on the left side of the moving device in the image forming apparatus body, as viewed from obliquely above and in front.

FIG. 17 is an exploded perspective view of the end portion on the left side of the moving device in the image forming apparatus body, as viewed from obliquely above and in front.

FIG. 18 is an exploded perspective view of the end portion on the left side of the moving device in the image forming apparatus body, as viewed from obliquely above and behind.

FIG. 19 is a cross-sectional view illustrating the print head and the moving device portion in the image forming apparatus body according to the present embodiment.

FIG. 20 is a perspective view of a cleaning member and another example of the print head, as viewed from obliquely above on the left side.

FIG. 21 is a side view of the cleaning member and the other example of the print head illustrated in FIG. 20.

### DETAILED DESCRIPTION OF THE INVENTION

Embodiments according to the present disclosure will be described below with reference to the drawings. In the following description, the same components are denoted by the same reference numerals. Their names and functions are also the same. Accordingly, detailed descriptions thereof are not repeated.

### Image Forming Apparatus

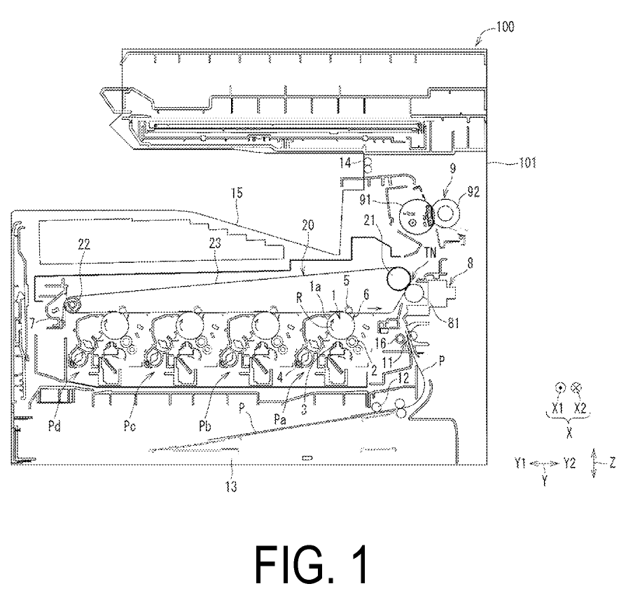

FIG. 1 is a cross-sectional view illustrating an image forming apparatus 100 according to the present embodiment. Note that the description will be given below assuming that in the drawings, a left/right direction is an X direction along the rotation axis direction of a photoreceptor drum 1, a right side is an X1 direction, a left side is an X2 direction, a front/rear direction is a Y direction orthogonal to the rotation axis direction of the photoreceptor drum 1, a front side is a Y1 direction, a rear side is a Y2 direction, and an up/down direction is a Z direction.

The image data to be handled by an image forming apparatus body 101 of the image forming apparatus 100 corresponds to either a color image using each color of black (K), cyan (C), magenta (M), and yellow (Y), or a monochrome image using a single color (e.g., black). Accordingly, four photoreceptor drums 1 (an example of an image carrier), four chargers 2, four print heads 3, four development devices 4, four primary transfer devices 5, and four drum cleaning devices 6 are provided to form four types of toner images corresponding to respective colors. These are respectively associated with black, cyan, magenta, and yellow, thereby forming four image stations Pa, Pb, Pc, and Pd. Note that the image forming apparatus 100 may be a monochrome image forming apparatus.

At the image stations Pa, Pb, Pc, and Pd, the chargers 2 uniformly charge, to a predetermined potential, surfaces 1a of the photoreceptor drums 1 rotationally driven in a predetermined rotation direction R. The print heads 3 expose the surfaces 1a of the photoreceptor drums 1, thereby forming electrostatic latent images on the surfaces 1a of the photoreceptor drums 1. The development devices 4 develop the electrostatic latent images on the surfaces 1a of the photoreceptor drums 1 to form toner images on the surfaces 1a of the photoreceptor drums 1. Thus, the toner images of the respective colors are formed on the surfaces 1a of the photoreceptor drums 1. The drum cleaning devices 6 remove and collect the residual toner on the surfaces 1a of the photoreceptor drums 1. The primary transfer devices 5 sequentially superimpose and transfer the color toner images on the surfaces 1a of the photoreceptor drums 1 to an intermediate transfer belt 23 circulated by a driving roller 21 and a driven roller 22 of a belt drive device 20, thereby forming color toner images on the intermediate transfer belt 23. A belt cleaning device 7 removes and collects the residual toner on the intermediate transfer belt 23.

A transfer nip portion TN is formed between the intermediate transfer belt 23 and a transfer roller 81 of a secondary transfer device 8. The transfer roller 81 of the secondary transfer device 8 conveys, together with the intermediate transfer belt 23, a sheet P such as a recording sheet or the like that has been conveyed through a sheet conveyance path 11 by sandwiching the sheet P at the transfer nip portion TN, while transferring the color toner images on the surface of the intermediate transfer belt 23 onto the sheet P. A fixing device 9 fixes the color toner image on the sheet P by applying heat and pressure with the sheet P sandwiched between a fixing member (a fixing belt 91 in this example) and a pressing member (a pressure roller 92 in this example).

The sheet P is drawn out from a sheet feeding cassette 13 by a pickup roller 12, conveyed through the sheet conveyance path 11, passed through the secondary transfer device 8 and the fixing device 9, and discharged to a discharge tray 15 via a discharge roller 14. A registration roller 16 and the like are disposed in the sheet conveyance path 11. The registration roller 16 temporarily stops the sheet P and aligns a leading end of the sheet P, and then starts the conveyance of the sheet P in synchronization with the transfer timing for the toner image at the transfer nip portion TN between the intermediate transfer belt 23 and the transfer roller 81.

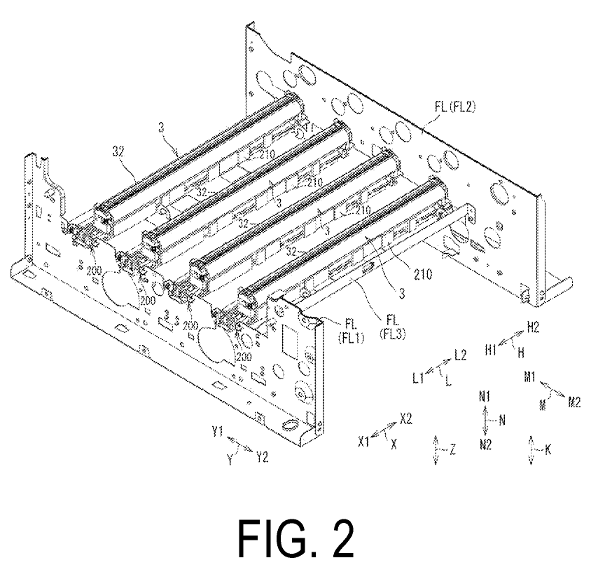

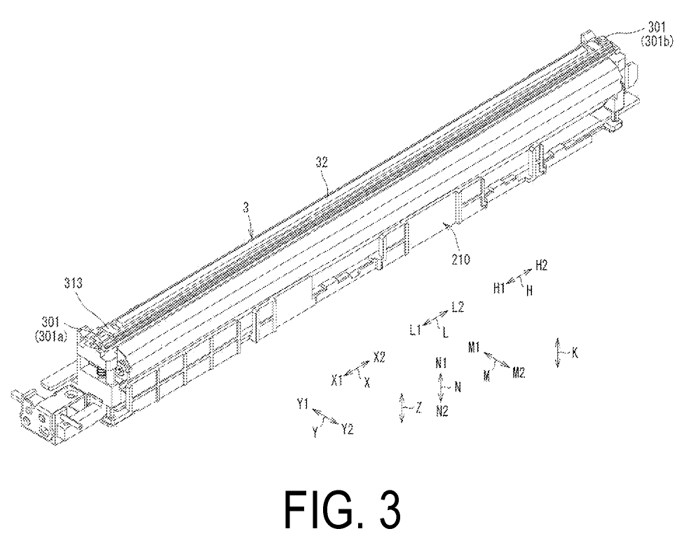

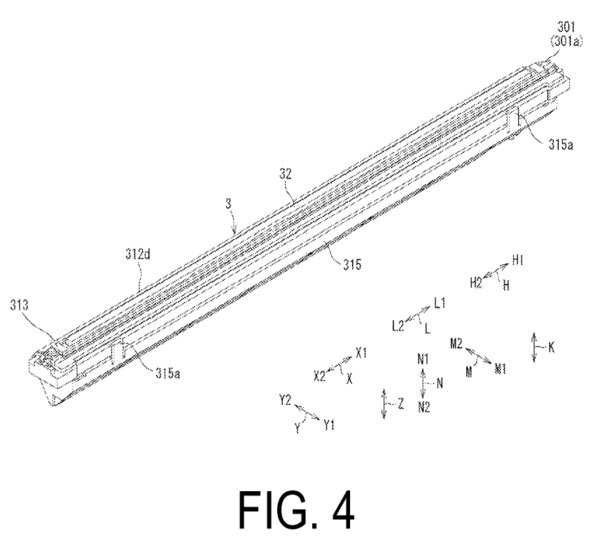

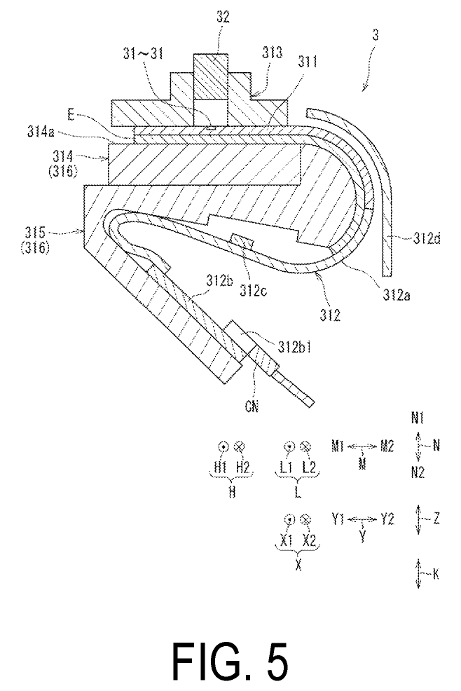

FIG. 2 is a perspective view of an example of the print heads 3 in the image forming apparatus 100 according to the present embodiment provided at main body frames FL (FL1 to FL3), as viewed from obliquely above on the right side X1. FIG. 3 is a perspective view of a state in which the print head 3 illustrated in FIG. 2 is supported by an installation portion 210, as viewed from obliquely above on the right side X1. FIG. 4 is a perspective view of the print head 3 as viewed from obliquely above on the left side X2. FIG. 5 is a cross-sectional view schematically illustrating the print head 3.

In the following description, a plurality of light-emitting elements 31 (see FIG. 5) in the print heads 3 will be described as organic light-emitting diodes (OLED, hereinafter simply called OLED). Note that the light-emitting elements 31 are not limited to OLEDs, and may be light-emitting elements such as inorganic light-emitting diodes (LED) or nano light-emitting diodes (nanoscale light-emitting diodes), which are light-emitting diodes (LED) smaller than micrometers, for example.

Note that since the print heads 3 and the like have an identical configuration, they are illustrated in one drawing in and after FIG. 3, and in the following description, the print heads 3 and the like are simply called the print head 3 and the like.

The image forming apparatus 100 according to the present embodiment includes the photoreceptor drum 1 and the print head 3 that is elongated. The print head 3 includes a light-emitting element panel 311 (an example of a substrate) and a lens array 32. The light-emitting element panel 311 extends in a longitudinal direction L and includes the plurality of light-emitting elements 31. The light-emitting elements 31 emit light for exposing the surface 1a of the photoreceptor drum 1. The light-emitting elements 31 are arranged side by side in the longitudinal direction L of the print head 3 and are arrayed in a line. In this example, the light-emitting element panel 311 is a film-shaped panel (flexible OLED panel) (light-emitting element panel) on which the OLED elements (31) are mounted. Doing this enables the print head 3 to be reduced in size and cost.

The lens array 32 extends in the longitudinal direction L and condenses, onto the surface 1a of the photoreceptor drum 1, the light emitted by the light-emitting elements 31. The lens array 32 is disposed to oppose the light-emitting elements 31.

The installation portion 210 is provided with the print head 3. The installation portion 210 is installed between the main body frames FL (between the main body frame FL1 on the right side X1 and the main body frame FL2 on the left side X2 in this example) of the image forming apparatus body 101 (see FIG. 1).

In this example, the main body frame FL3 is installed along a direction orthogonal to the up/down direction Z between the main body frames FL1 and FL2. The installation portion 210 is placed on the main body frame FL3.

### Print Head

As illustrated in FIG. 5, the print head 3 further includes a drive member 312, a lens holding member 313, a panel holding member 314 (base member), and a main body member 315. The panel holding member 314 and the main body member 315 constitute a support member 316. The drive member 312 drives the light-emitting elements 31. The lens holding member 313 holds the lens array 32. The panel holding member 314 is made of a rigid material, and fixes the lens holding member 313 in a state where the light-emitting element panel 311 is fixed. The main body member 315 holds the drive member 312, the lens holding member 313, and the panel holding member 314. The lens holding member 313 and the panel holding member 314 extend in the longitudinal direction L.

In this example, the drive member 312 includes a flexible circuit board 312a (connection cable member), a printed wiring board (PWB) 312b (connection board), a drive circuit element 312c, and a protective member 312d. The connection cable member (312a) has one end portion connected to one end portion of the light-emitting element panel 311, and the other end portion connected to one end portion of the printed wiring board 312b. The connection cable member (312a) is a flexible circuit board (Chip on Film: COF) in which the drive circuit element 312c (driver IC) that drives the OLED elements (31) on the light-emitting element panel 311 is mounted on a film. The printed wiring board 312b connected to the connection cable member (312a) has an input terminal 312b1 (connector terminal), and is connected to a connector CN via the input terminal 312b1. The protective member 312d protects exposed portions of the light-emitting element panel 311 and the connection cable member (312a). The connector CN is connected to an image processing apparatus (not illustrated) provided in the image forming apparatus body 101. The light-emitting elements 31 are provided inside (e.g., deposited) so as not to protrude from the outer surface of the light-emitting element panel 311.

The panel holding member 314 is formed in a rectangular parallelepiped shape. On a front surface 314a of the panel holding member 314 on the photoreceptor drum 1 side (one side N1) in an optical axis direction N, a back surface of the light-emitting element panel 311 provided with the light-emitting elements 31 on the side opposite to the light-emitting elements 31 is bonded by an adhesive member E (e.g., double-sided adhesive tape) (see FIG. 5).

### Present Embodiment

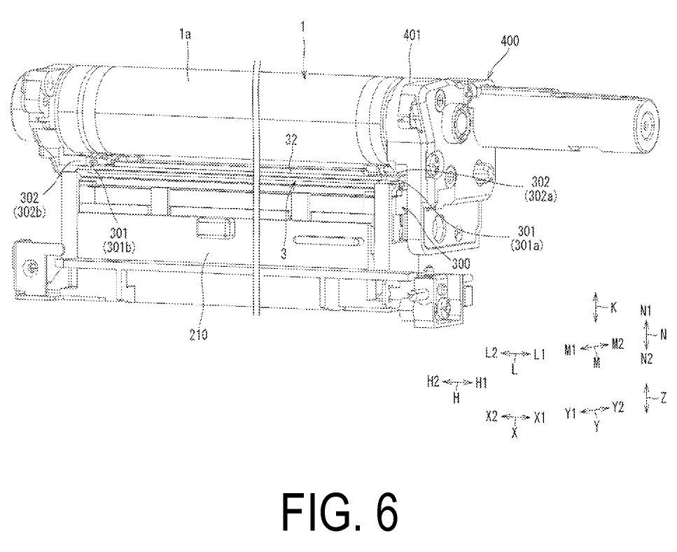

Next, an example of a detachable member (70) and an example of a moving device 300 will be described below with reference to FIGS. 6-19.

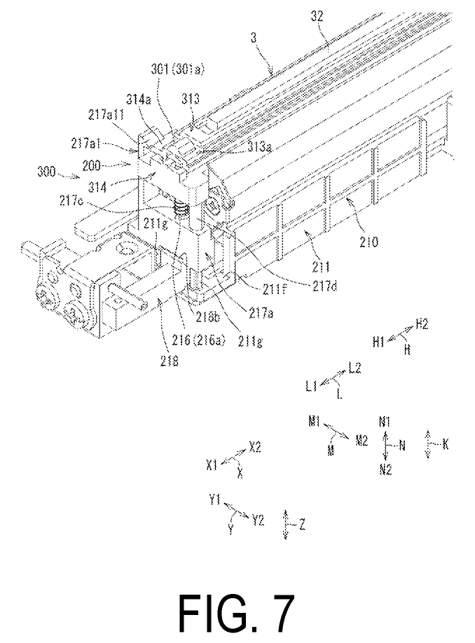

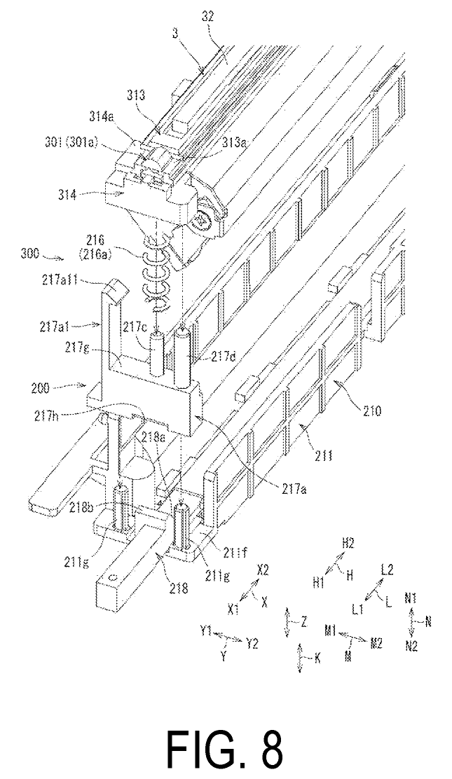

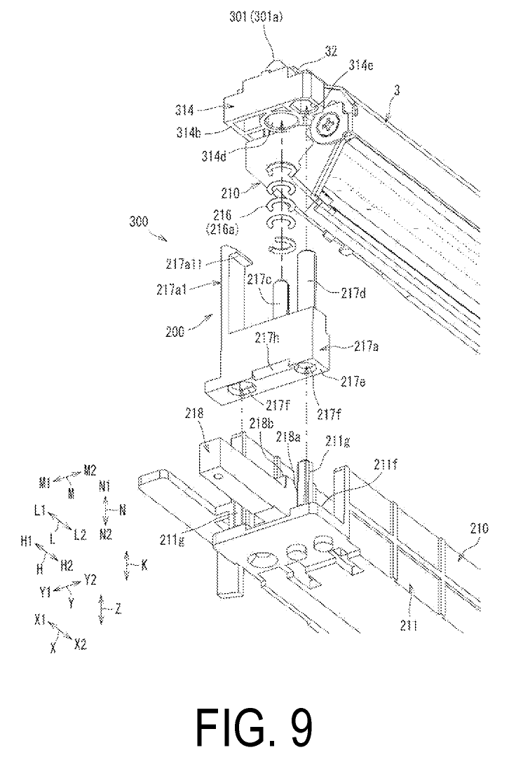

FIG. 6 is a perspective view of a photoreceptor unit 400, the print head 3, and the installation portion 210, as viewed from above on the left side X2. FIG. 7 is a perspective view of the moving device 300 portion on one side L1 of the installation portion 210 provided with the print head 3, as viewed from obliquely above. FIGS. 8 and 9 are exploded perspective views of the print head 3 and the installation portion 210 illustrated in FIG. 7, as viewed from obliquely above and obliquely below, respectively.

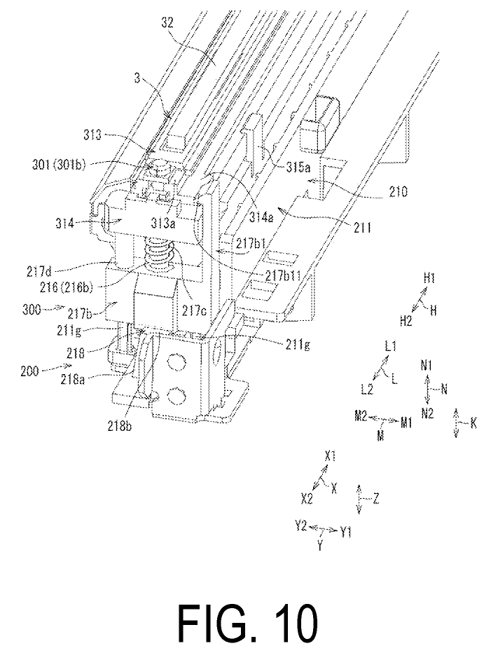

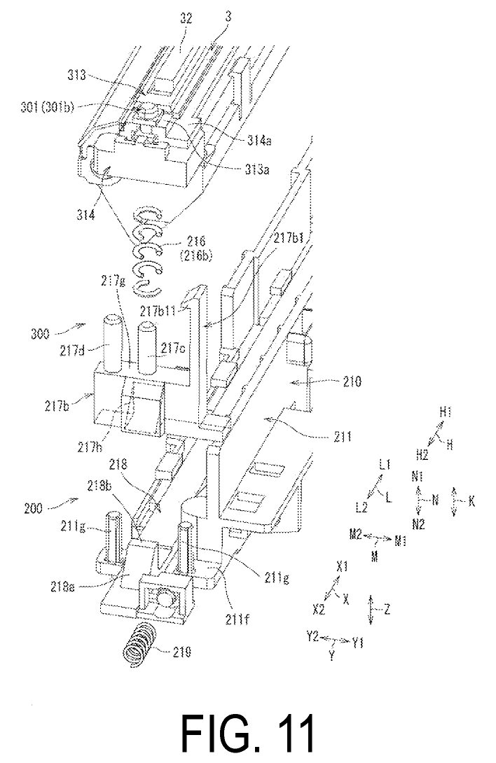

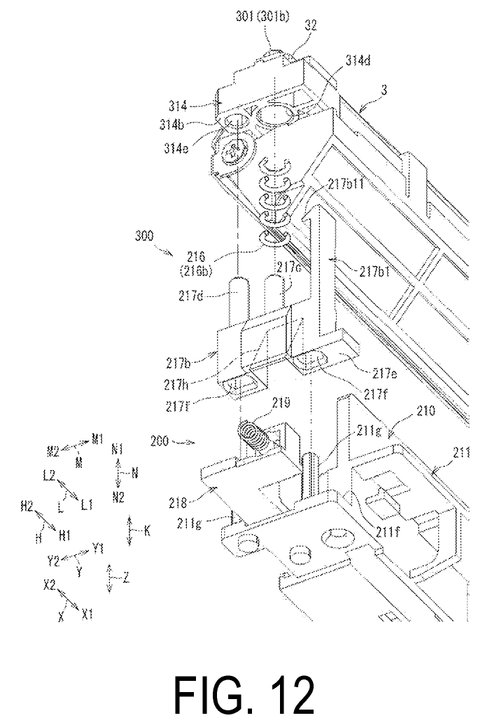

FIG. 10 is a perspective view of the moving device 300 portion on another side L2 of the installation portion 210 provided with the print head 3, as viewed from obliquely above. FIGS. 11 and 12 are exploded perspective views of the print head 3 and the installation portion 210 illustrated in FIG. 10, as viewed from obliquely above and obliquely below, respectively.

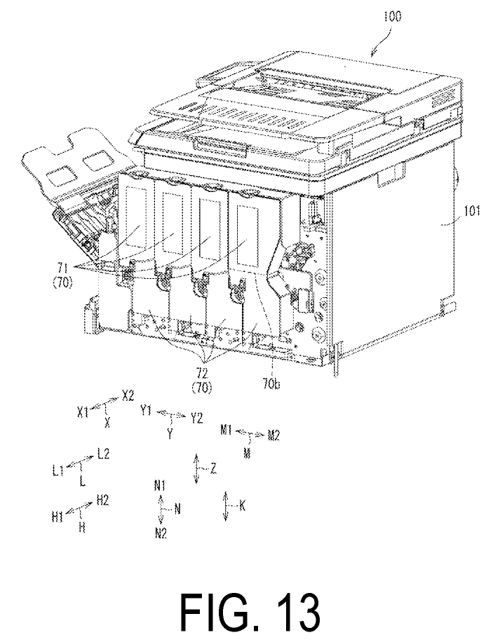

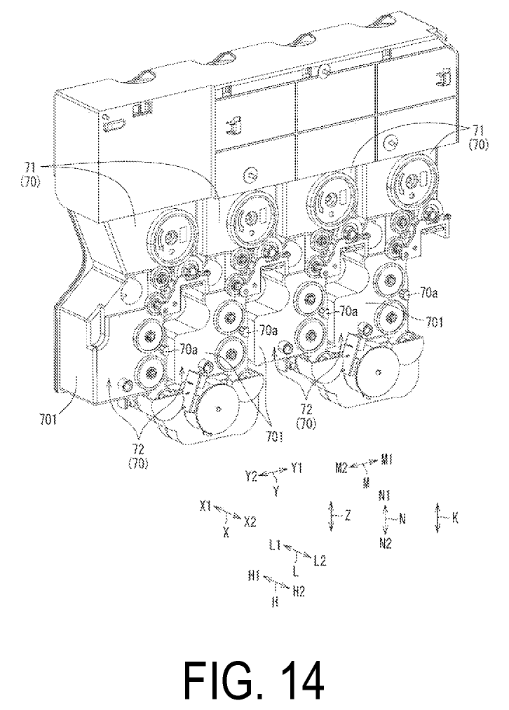

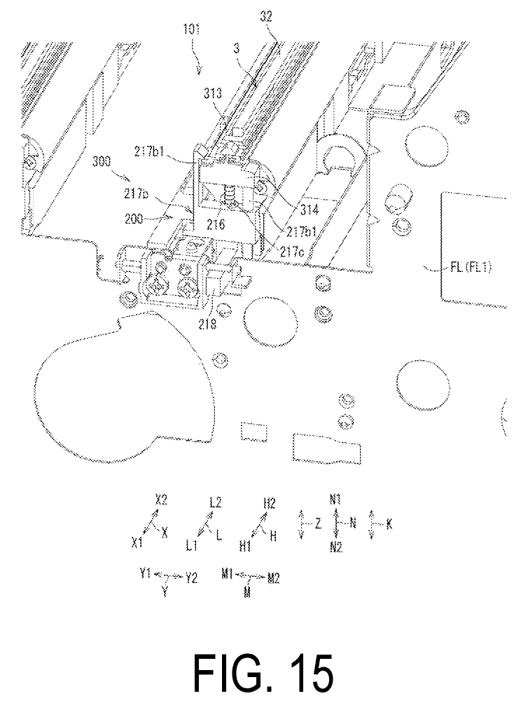

FIG. 13 is a perspective view of a state in which an exterior cover member on the surface of the right side X1 is removed in the image forming apparatus 100, as viewed from obliquely above and behind the right side X1. FIG. 14 is a perspective view of integrated cartridges 70 including toner containers 71 and a waste toner container 72, as viewed from obliquely above and behind the left side X2. FIG. 15 is a perspective view of an end portion on the right side X1 of the moving device 300 in the image forming apparatus body 101, as viewed from obliquely above and behind.

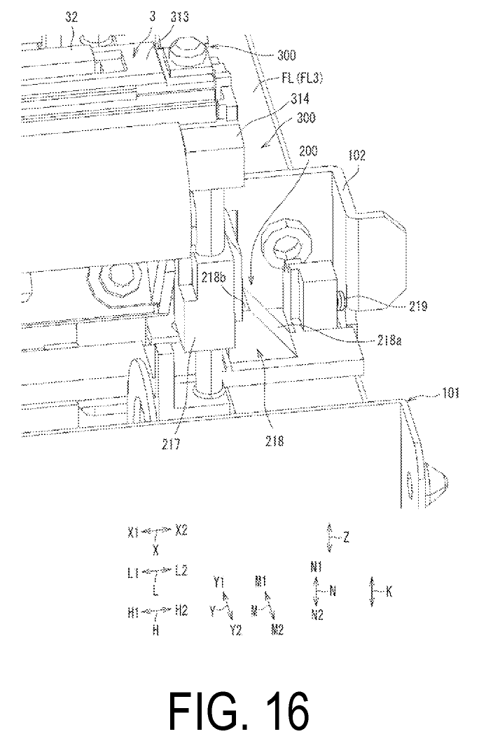

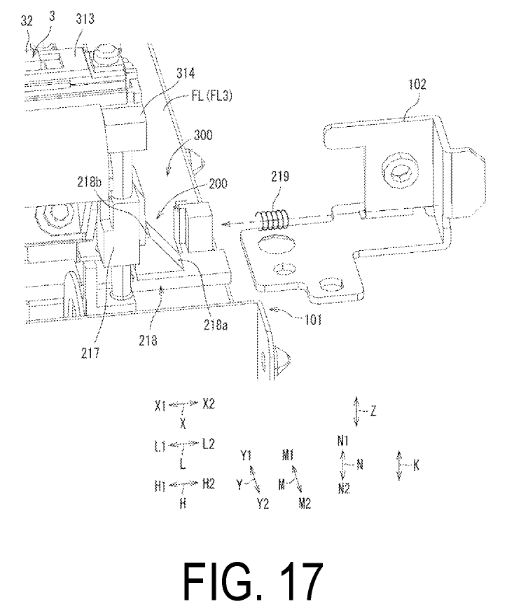

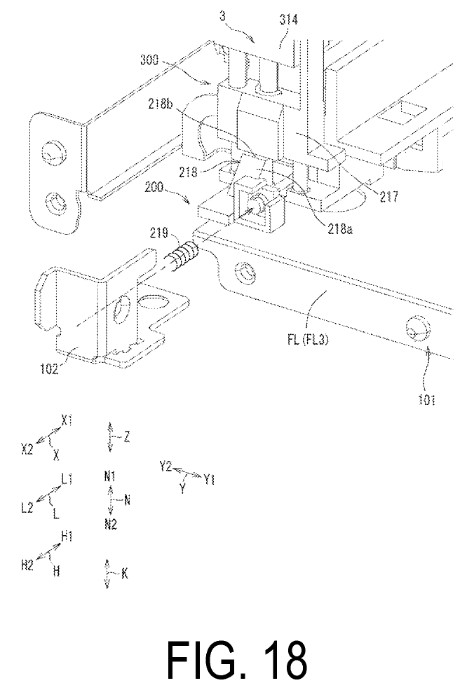

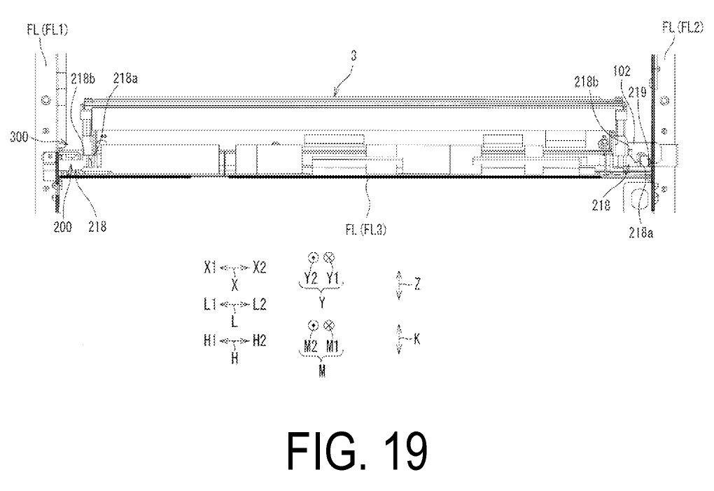

FIGS. 16 and 17 are a perspective view and an exploded perspective view, respectively, of the end portion on the left side X2 of the moving device 300 in the image forming apparatus body 101, as viewed from obliquely above and in front. FIG. 18 is an exploded perspective view of the end portion on the left side X2 of the moving device 300 in the image forming apparatus body 101, as viewed from obliquely above and behind. FIG. 19 is a cross-sectional view illustrating the print head 3 and the moving device 300 portion in the image forming apparatus body 101 according to the present embodiment.

The image forming apparatus 100 according to the present embodiment further includes the detachable member (70) detachable from the image forming apparatus body 101, and the moving device 300.

The image forming apparatus 100 includes the toner container 71 (toner cartridge) (see FIGS. 13 and 14) and the waste toner container 72 (see FIGS. 13 and 14). The toner container 71 stores toner. The waste toner container 72 stores waste toner. In this example, the toner container 71 and the waste toner container 72 are integrally formed, thereby constituting the integrated cartridge 70 (an example of a detachable member). The integrated cartridge 70 is attached to the image forming apparatus body 101 from a direction (the left side X2 direction in this example) on any one side in the left-right direction X. Specifically, the integrated cartridge 70 is provided on one side (the right side X1 in this example) in the left-right direction X in the image forming apparatus body 101. Specifically, the integrated cartridge 70 is detached to one side (X1) in the left-right direction X with respect to the image forming apparatus body 101, is attached from the one side (X1) to the other side (X2) in the left-right direction X, and is attached to the right side surface of the image forming apparatus body 101.

The integrated cartridge 70 is provided with two containers above and below with a partition wall 70b (see FIG. 13) in between in one container. The toner container 71 is the upper container, and the waste toner container 72 is the lower container.

The moving device 300 moves the print head 3 with respect to the photoreceptor drum 1 in conjunction with attachment/detachment of the detachable member (70) to/from the image forming apparatus body 101. The moving device 300 includes a lifting mechanism 200 and a lifting member 218. The lifting mechanism 200 lifts and lowers the print head 3 in a lifting direction K along the optical axis direction N of the light-emitting elements 31. The lifting member 218 is configured to be movable in a predetermined moving direction H orthogonal to the lifting direction K.

The lifting mechanism 200 lowers the print head 3 by the lifting member 218 moving to one side H1 in the moving direction H when the detachable member (70) is detached from the image forming apparatus body 101, and raises the print head 3 by the lifting member 218 moving to another side H2 in the moving direction H when the detachable member (70) is attached to the image forming apparatus body 101.

Specifically, the lifting mechanism 200 positions the print head 3 with respect to the photoreceptor drum 1 so as to maintain a constant distance (focal length) between the print head 3 and the photoreceptor drum 1.

The lifting mechanism 200 includes positioners 301 (301a and 301b) and positionees 302 (302a and 302b). The positioners 301 (301a and 301b) are provided at the print head 3 to determine the position of the print head 3 with respect to the photoreceptor drum 1. The positioners 301 (301a and 301b) are provided at the lens holding member 313. The positionees 302 (302a and 302b) are provided at a main body side member [a housing 401 (see FIG. 6) of the photoreceptor drum 1 in this example] that is a member on the image forming apparatus body 101 side to abut the positioners 301 (301a and 301b).

The moving device 300 further includes biasing members 216 (216a and 216b) (see FIGS. 7-12) that bias the print head 3 toward the main body side member (the housing 401 of the photoreceptor drum 1 in this example) via the positioners 301 (301a and 301b). The positionees 302 (302a and 302b) abut the positioners 301 (301a and 301b) by being biased by the biasing members 216 (216a and 216b). Here, a plurality of holders 315a (see FIGS. 4 and 10) in the lens holding member 313 provided with the positioners 301 (301a and 301b) have an action of regulating excessive movement of the panel holding member 314 on the main body side member (401) side by the biasing members 216 (216a and 216b).

In this configuration, the biasing members 216 (216a and 216b) can cause the positioners 301 (301a and 301b) to reliably abut the positionees 302 (302a and 302b), thereby enabling the distance between the print head 3 and the photoreceptor drum 1 to be stably maintained.

In this example, the positioners 301 are a pair of the positioners 301a and 301b provided on both sides in the longitudinal direction L of the print head 3, respectively. The positionees 302 are the pair of positionees 302a and 302b corresponding to a pair of the positioners 301a and 301b, respectively. The pair of positioners 301a and 301b are provided at both end portions (outside the lens array 32) in the longitudinal direction L on a surface 313a of the lens holding member 313 on the lens array 32 side. The biasing members 216 are a pair of the biasing members 216a and 216b.

The lifting mechanism 200 further includes a pair of holders 217a and 217b. The pair of holders 217a and 217b are provided movably in the optical axis direction N at both end portions (outside the print head 3) in the longitudinal direction L of an installation portion body 211. The print head 3 is provided movably in the optical axis direction N with respect to the pair of holders 217a and 217b. The print head 3 is biased toward the photoreceptor drum 1 by the pair of biasing members 216a and 216b disposed between the pair of holders 217a and 217b in a state where the movement to the one side N1 in the optical axis direction N is regulated by regulators 217a1 and 217b1.

Specifically, insertion protrusions (217c and 217d) are erected on surfaces 217g of the pair of holders 217a and 217b on the installation portion 210 side. The insertion protrusions (217c and 217d) extend toward the print head 3 side (the one side N1) in the optical axis direction N. A back surface 314b of the panel holding member 314 is provided with insertion recesses (314d and 314e) (see FIGS. 9 and 12) through which the insertion protrusions (217c and 217d) are inserted, respectively. This can regulate the print head 3 in the longitudinal direction L and a width direction M with respect to the pair of holders 217a and 217b, and make the print head 3 movable in the optical axis direction N with respect to the pair of holders 217a and 217b. The pair of biasing members 216a and 216b are coil springs, and are inserted through the insertion protrusions 217c on one side M1 between the panel holding member 314 and the pair of holders 217a and 217b. This can bias the print head 3 toward the photoreceptor drum 1 with respect to the pair of holders 217a and 217b.

The pair of holders 217a and 217b is provided with the regulators 217a1 and 217b1. The pair of holders 217a and 217b and the regulators 217a1 and 217b1 are integrally formed. The regulators 217a1 and 217b1 detachably regulate the movement of the panel holding member 314 in the print head 3 to the one side N1 in the optical axis direction N. The regulators 217a1 and 217b1 have locks 217a11 and 217b11 that lock the front surface 314a of the panel holding member 314.

On a surface 211f of the installation portion body 211 on the print head 3 side, insertion protrusions (211g and 211g) and (211g and 211g) are erected at both end portions in the longitudinal direction L. The insertion protrusions (211g and 211g) and (211g and 211g) extend toward the one side N1 in the optical axis direction N. Back surfaces 217e of the pair of holders 217a and 217b on the installation portion 210 side are provided with insertion recesses (217f and 217f) and (217f and 217f) (see FIGS. 9 and 12) through which the insertion protrusions (211g and 211g) and (211g and 211g) are inserted, respectively. This can regulate the pair of holders 217a and 217b in the longitudinal direction L and the width direction M with respect to the installation portion body 211, and make the pair of holders 217a and 217b movable to the one side N1 and another side N2 in the optical axis direction N with respect to the installation portion body 211.

The lifting member 218 is movable in the moving direction H (the longitudinal direction L) with respect to the installation portion body 211, and movement in the moving direction H lifts and lowers the pair of holders 217a and 217b with respect to the photoreceptor drum 1.

The lifting member 218 extends in the moving direction H and is provided between the pair of holders 217a and 217b and the surface 211f of the installation portion body 211. The lifting member 218 is provided with a plurality of (two) inclined surfaces 218a and 218a (see FIGS. 8-11) and top surfaces 218b and 218b (see FIGS. 8-11). The inclined surfaces 218a and 218a are inclined so as to move the pair of holders 217a and 217b on a receding side and an approaching side with respect to the photoreceptor drum 1, respectively, while sliding with the pair of holders 217a and 217b along with the movement of the lifting member 218 to any of the one side H1 and the other side H2 in the moving direction H. The pair of holders 217a and 217b are provided with inclined surfaces 217h and 217h (see FIGS. 11 and 12). The inclined surfaces 217h and 217h are provided at locations corresponding to the inclined surfaces 218a and 218a in the lifting member 218 of the pair of holders 217a and 217b, and are inclined along the inclined surfaces 218a and 218a.

In this example, the moving device 300 further includes a biasing member 219 (a coil spring in this example) (see FIGS. 11, 12, and 16-18) that biases the lifting member 218 toward the detachable member (70) side.

The biasing member 219 is provided between the lifting member 218 and a fixed portion 102 (see FIGS. 16-19) fixed to the main body frame FL3 so as to bias the lifting member 218 toward the detachable member (70) side.

In the moving device 300 described above, in a state where the detachable member (70) is attached to the image forming apparatus body 101, the detachable member (70) abuts the lifting member 218, and the print head 3 is positioned at a close position close to the surface 1a of the photoreceptor drum 1.

Specifically, the top surfaces 218b and 218b of the lifting member 218 are in contact with the back surfaces 217e of the pair of holders 217a and 217b to place the pair of holders 217a and 217b. Thus, the print head 3 is close to the photoreceptor drum 1 with a predetermined distance, and can be brought into an image formable state.

In this state, when an operator detaches the detachable member (70) from the image forming apparatus body 101 and releases the abutment of the detachable member (70) with the lifting member 218, the lifting member 218 moves to a detachment position on the other side H2 in the moving direction H. At this time, the lens array 32 of the print head 3 is separated from the surface 1a of the photoreceptor drum 1.

Specifically, when the abutment of the detachable member (70) with the lifting member 218 is released by the detachment operation on the detachable member (70) by the operator, the lifting member 218 moves from the close position to the one side H1 in the moving direction H by the biasing force of the biasing member 219. Then, the top surfaces 218b and 218b of the lifting member 218 are separated from the back surfaces 217e of the pair of holders 217a and 217b, and the inclined surfaces 218a and 218a slide on the inclined surfaces 217h and 217h of the pair of holders 217a and 217b. At this time, the action of the biasing force on the pair of holders 217a and 217b by the biasing members 216a and 216b is released, and the pair of holders 217a and 217b recede (lower) from the photoreceptor drum 1. When the lifting member 218 further moves to the one side H1 in the moving direction H, the lifting member 218 reaches a separation position, and the lens array 32 of the print head 3 is separated from the surface 1a of the photoreceptor drum 1. This allows a worker to reliably clean a surface 32a of the lens array 32.

On the other hand, when the operator attaches the detachable member (70) to the image forming apparatus body 101 and the detachable member (70) abuts the lifting member 218, the lifting member 218 moves to the close position on the other side H2 in the moving direction H. At this time, the lens array 32 of the print head 3 is close to the surface 1a of the photoreceptor drum 1.

Specifically, when the detachable member (70) abuts the lifting member 218 by the attachment operation on the detachable member (70) by the operator, the lifting member 218 moves from the separation position to the other side H2 in the moving direction H against the biasing force of the biasing member 219. Then, the inclined surfaces 218a and 218a of the lifting member 218 slide with the inclined surfaces 217h and 217h of the pair of holders 217a and 217b. At this time, the biasing members 216a and 216b exert a biasing force on the pair of holders 217a and 217b, causing the pair of holders 217a and 217b to approach (rise toward) the photoreceptor drum 1. When the lifting member 218 further moves to the other side H2 in the moving direction H, the top surfaces 218b and 218b come into contact with the back surfaces 217e of the pair of holders 217a and 217b to place the pair of holders 217a and 217b, and the lifting member 218 reaches the close position. Thus, the print head 3 is close to the photoreceptor drum 1 with a predetermined distance, and can be brought into an image formable state.

In this manner, according to the present embodiment, when the print head 3 is moved, since the lifting member 218 is moved in the predetermined moving direction H orthogonal to the lifting direction K, it is possible to reduce the space for moving the print head 3 accordingly, thereby achieving downsizing of the image forming apparatus body 101.

Moreover, in a case where the print head is rotated as in the related art, the structure for moving the print head becomes complicated, but in the present embodiment, since the lifting member 218 is moved in the moving direction H, the structure for moving the print head 3 can be simplified.

### First Embodiment

In the present embodiment, the detachable member (70) includes a projection 70a (see FIG. 14) that presses the lifting member 218 toward the other side H2 in the moving direction H when attached to the image forming apparatus body 101. Specifically, the projection 70a protrudes from a surface of a detachable member body 701 on the lifting member 218 side toward the lifting member 218 side. The projection 70a releases the pressing of the lifting member 218 toward the other side H2 in the moving direction H when detached from the image forming apparatus body 101.

This configuration can reliably move the lifting member 218 to the other side H2 in the moving direction H by the projection 70a of the detachable member 70.

### Second Embodiment

In the present embodiment, the inclined surface 218a of the lifting member 218 is movable in the moving direction H along the rotation axis direction (X) of the photoreceptor drum 1, and is inclined such that the height in the optical axis direction N decreases from the one side H1 toward the other side H2 in the moving direction H.

In this configuration, use of the inclined surface 218a of the lifting member 218 can reliably lift and lower the print head 3.

### Third Embodiment

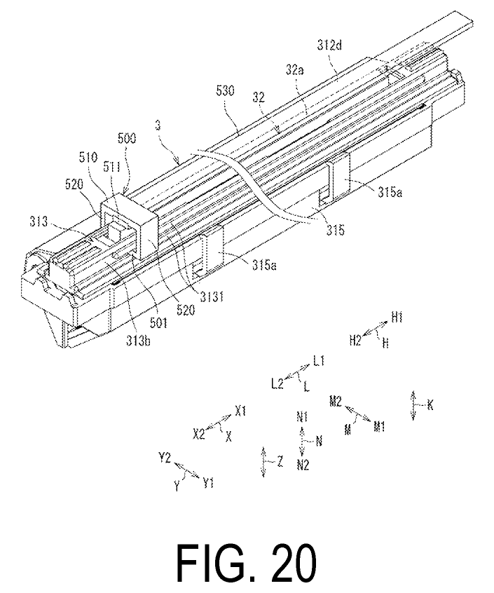

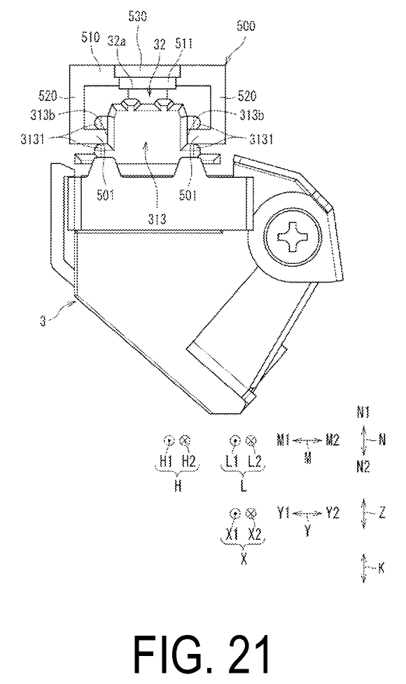

FIG. 20 is a perspective view of a cleaning member 500 and another example of the print head 3, as viewed from obliquely above on the left side X2. FIG. 21 is a side view of the cleaning member 500 and the other example of the print head 3 illustrated in FIG. 20.

Even in a state where the photoreceptor drum 1 and the lens array 32 are separated from each other, it is difficult for the worker to easily clean the surface 32a of the lens array 32.

In this respect, the image forming apparatus 100 according to the present embodiment further includes the cleaning member 500 (cleaning rod) having a cleaning tool 511 (e.g., a cleaning sheet such as nonwoven fabric) for cleaning the lens array 32. The cleaning member 500 is movable in the moving direction H along the rotation axis direction (X) of the photoreceptor drum 1.

The cleaning member 500 cleans the surface 32a of the lens array 32 by moving in the moving direction H in a state where the cleaning tool 511 is in contact with the surface 32a of the lens array 32.

This configuration can reliably clean the surface 32a of the lens array 32 by the cleaning tool 511 of the cleaning member 500 in a state where the photoreceptor drum 1 and the lens array 32 are separated from each other.

Specifically, the cleaning member 500 includes a main body 510, an engagement portion 501, a coupler 520, and a handle 530. The main body 510 opposes the surface 32a of the lens array 32. The cleaning tool 511 is provided on the lens array 32 side of the main body 510. The engagement portion 501 is engaged movably in the moving direction H with respect to the lens holding member 313. The coupler 520 couples the main body 510 with the engagement portion 501. The handle 530 is gripped by the operator and moves the main body 510 together with the engagement portion 501 and the coupler 520 by a moving operation in the moving direction H by the operator. The handle 530 is joined to an end portion of the main body 510 on the one side H1 in the moving direction H and extends in the moving direction H.

Specifically, the engagement portion 501 is a pair of the engagement portions 501 and 501 opposing wall surfaces 313b and 313b on both sides (the one side M1 and the other side M2) in the width direction M orthogonal to both the optical axis direction N and the moving direction H of the lens holding member 313. The coupler 520 is a pair of the couplers 520 and 520 extending from both end portions in the width direction M of the main body 510 toward the lens holding member 313 side and having leading end portions to which the pair of engagement portions 501 and 501 are joined.

The wall surfaces 313b and 313b on both sides in the width direction M of the lens holding member 313 are provided with a pair of guides (3131 and 3131) and (3131 and 3131) extending in the moving direction H to protrude at a predetermined interval in the optical axis direction N. The pair of engagement portions 501 and 501 are sandwiched between the pair of guides (3131 and 3131) and (3131 and 3131).

In the cleaning member 500 described above, by the operator gripping the handle 530 of the cleaning member 500 to move the main body 510 in the moving direction H, the engagement portion 501 of the coupler 520 slides while being engaged with the lens holding member 313 in a state where the cleaning tool 511 of the main body 510 is in contact with the surface 32a of the lens array 32. This enables the cleaning tool 511 of the cleaning member 500 to reliably clean the surface 32a of the lens array 32.

### Fourth Embodiment

In the present embodiment, the detachable member (70) is the toner container 71 that stores toner and/or the waste toner container 72 that stores waste toner.

This configuration enables the surface 32a of the lens array 32 to be cleaned when the toner container 71 and/or the waste toner container 72 (the integrated cartridge 70 in this example) is attached to and detached from (particularly replaced with) the image forming apparatus body 101.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image forming apparatus comprising:
an image carrier;
a print head that is elongated including a substrate having a plurality of light-emitting elements arrayed in a line and a lens array that condenses, onto the image carrier, light emitted by the plurality of light-emitting elements;
a detachable member attachable/detachable to/from an image forming apparatus body; and
a moving device that moves the print head with respect to the image carrier in conjunction with attachment/detachment of the detachable member to/from the image forming apparatus body, wherein
the moving device includes a lifting mechanism that lifts and lowers the print head in a lifting direction along an optical axis direction of the light-emitting elements, and a lifting member that is movable in a predetermined moving direction orthogonal to the lifting direction, and the lifting mechanism lowers the print head by the lifting member moving to one side in the moving direction when the detachable member is detached from the image forming apparatus body, and raises the print head by the lifting member moving to the other side in the moving direction when the detachable member is detachably attached to the image forming apparatus body.

2. The image forming apparatus according to claim 1, wherein
the detachable member includes a projection that presses the lifting member toward the other side in the moving direction when attached to the image forming apparatus body.

3. The image forming apparatus according to claim 1, wherein
the lifting member is movable in the moving direction along a rotation axis direction of the image carrier, and has an inclined surface inclined such that a height in the optical axis direction decreases from the one side to the other side in the moving direction.

4. The image forming apparatus according to claim 1 further comprising
a cleaning member having a cleaning tool for cleaning the lens array, wherein
the cleaning member is movable in the moving direction along the rotation axis direction of the image carrier, and
the cleaning member cleans a surface of the lens array by moving in the moving direction in a state where the cleaning tool is in contact with the surface of the lens array.

5. The image forming apparatus according to claim 1, wherein
the detachable member is a toner container that stores toner and/or a waste toner container that stores waste toner.
